(19) United States
(12) Patent Application Publication
(10) Pub. No.: US 2010/0116615 A1
(43) Pub. Date: May 13, 2010

(54) POWER TRANSMITTING APPARATUS

(76) Inventors: Hidehiro Oba, Aichi-ken (JP); Hiromichi Kimura, Aichi-ken (JP)

Correspondence Address: KENYON & KENYON LLP, 1500 K STREET N.W., SUITE 700, WASHINGTON, DC, 20005, US

(21) Appl. No.: 12/594,550

(22) PCT Filed: Apr. 3, 2008
(86) PCT No.: PCT/JP2008/056695

§ 371 Date: Oct. 2, 2009

(30) Foreign Application Priority Data
Apr. 4, 2007 (JP) 2007-098400

(51) Int. Cl. F16D 27/01; F16D 27/00

(52) U.S. Cl. 192/84.3; 192/84.1

(57) ABSTRACT

A transmission includes a transmission case, an oil pan that is defined in a lower portion within the transmission case and stores a lubricating medium capable at least of lubricating components of the transmission, movable engagement members capable of engaging with two elements that respectively correspond thereto, and electromagnetic actuators that respectively move a corresponding one of the movable engagement members to allow a connection between the two elements and a release of the connection.

### TECHNICAL FIELD

The present invention relates to a power transmitting apparatus that has a plurality of elements including at least two rotating elements and is capable of transmitting power between the two rotating elements.

### BACKGROUND ART

There is known a conventional two-speed power transmitting unit for an electric scooter as an electric vehicle, that includes a dog clutch having a cylindrical clutch moving portion on which a permanent magnet is mounted and a cylindrical clutch driving portion on which an excitation coil is mounted, and an excitation circuit that reverses an acting force in response to a movement of the clutch moving portion by excitation of the clutch driving portion (see, Patent Document 1). In the power transmitting unit, thicknesses in both ends of a yoke of the clutch driving portion are larger than those in both ends of a yoke of the clutch moving portion. Accordingly, an attraction force acts between the permanent magnet of the clutch moving portion and the yoke of the clutch driving portion so as to generate force in an engagement direction of the clutch moving portion when the clutch moving portion is positioned in an end of a movement stroke. Further, there is known a conventional two/four wheel drive switching device for a part-time four-wheel drive vehicle, that includes a front wheel propeller shaft for driving front wheels and a rear wheel propeller shaft for driving rear wheels (see, Patent Document 2). The switching device interlockingly connects one of the propeller shafts with an output shaft of a transmission in a full-time connection state. The other of the propeller shafts is interlockingly and intermittently connected with the one propeller shaft with a clutch member movable between a connection position and a disconnection position. In the two/four wheel drive switching device, a hydraulic actuator for moving the clutch member is disposed in a lower portion within a crankcase.

### [Patent Document 1] Japanese Patent Laid-Open No. 2003-235115

[Patent Document 2] Japanese Patent Laid-Open No. H11-151947

### DISCLOSURE OF THE INVENTION

According to the above power transmitting unit, a position of the clutch moving portion can be fixed when the clutch moving portion reaches the end of the movement stroke even if the excitation coil of the clutch driving portion is in a non-excitation state. However, outer diameters of the clutch moving portion and the clutch driving portion should be enlarged to some extent in order to satisfactorily ensure the attraction force when the clutch moving portion and the clutch driving portion are formed in a cylindrical shape as described above. Thus, the power transmitting unit may be upsized. Further, in a dog clutch driven by an electromagnetic actuator as described above, the challenge is to reduce noise resulted from a magnetic coupling between the magnet and another member.

The present invention has an object to provide a power transmitting apparatus that can be configured to be compact and is capable of reducing operating noise of an electromagnetic actuator.

The present invention accomplishes the demands mentioned above by the following configurations applied to a power transmitting apparatus.

A power transmitting apparatus according to the present invention is a power transmitting apparatus that has a plurality of elements including at least two rotating elements and is capable of transmitting power between the two rotating elements. The power transmitting apparatus includes a casing that houses the plurality of elements, a lubricating medium reservoir defined in a lower portion within the casing, the lubricating medium reservoir storing a lubricating medium capable at least of lubricating the plurality of elements, and a connecting unit including a movable engagement member capable of engaging with at least two elements among the plurality of elements, and an electromagnetic actuator disposed in the lubricating medium reservoir and connected with the movable engagement member, the electromagnetic actuator moving the movable engagement member to allow a connection between at least the two elements among the plurality of elements and a release of the connection.

The power output apparatus includes the casing that houses the plurality of elements including at least two rotating elements, the lubricating medium reservoir defined in the lower portion within the casing and storing the lubricating medium capable at least of lubricating the plurality of elements, and the connecting unit that allows the connection between at least the two elements among the plurality of elements and the release of the connection. The connecting unit includes the movable engagement member capable of engaging with at least two elements among the plurality of elements, and the electromagnetic actuator disposed in the lubricating medium reservoir and connected with the movable engagement member. The electromagnetic actuator moves the movable engagement member to allow the connection between at least the two elements among the plurality of elements and the release of the connection. As described above, the movable engagement member capable of engaging with at least the two elements is connected with the electromagnetic actuator disposed in the lower portion within the casing. Thus, the whole of the power transmitting apparatus can be configured to be compact in comparison with an apparatus including an electromagnetic actuator having a cylindrical shape. Further, lubricating function and shock absorbing function of the lubricating medium ensure smooth operation of the electromagnetic actuator and reduce operation noise of the electromagnetic actuator by disposing the electromagnetic actuator in place within the lubricating medium reservoir.

The electromagnetic actuator may include an actuator shaft connected with the movable engagement member and, movable in a predetermined direction, a permanent magnet secured to the actuator shaft, a couple of fixed magnetic poles arranged so that the permanent magnet is positioned between the fixed magnetic poles, and a polarity changing device capable of changing a polarity of each of the fixed magnetic poles. According to the electromagnetic actuator, it is possible to release a magnetic coupling between the permanent magnet and one of the fixed magnetic poles and to move the actuator shaft together with the movable engagement member by changing the polarity of each of the fixed magnetic poles. After a magnetic coupling between the permanent magnet and the other of the fixed magnetic poles, it is possible to readily and reliably retain a connection or a disconnection between at least the two elements by means of the movable engagement member even if a setting of the polarity of each of the fixed magnetic poles is released. Further, the shock absorbing function of the lubricating medium favorably reduces noise due to the permanent magnet and the fixed magnetic pole by disposing the electromagnetic actuator in the lubricating medium reservoir.

The power transmitting apparatus may further include a bearing that supports one end portion of the actuator shaft. The one end portion may be further than the other end of the actuator shaft from the permanent magnet. Thus, it is possible to prevent the actuator shaft from inclining and to smoothly move the actuator shaft or the movable engagement member.

The movable engagement member and the actuator shaft may be connected with each other via a connecting member. The connecting member may be formed so that a size of a portion secured to the actuator shaft is larger than a size of a portion secured to the movable engagement member. Thus, rigidity of a securing portion between the actuator shaft and the connecting member can be increased, thereby preventing the actuator shaft from inclining and smoothly moving the actuator shaft. In this structure, particularly, the movable engagement member is advantageously formed as a relatively thin ring-shaped member.

The power transmitting apparatus may further include a movable shaft secured to the movable engagement member and connected with the actuator shaft. The actuator shaft and the movable shaft may be arranged offset from each other. Thus, the electromagnetic actuator can be flexibly disposed within the lubricating medium reservoir, so that the whole of the power transmitting apparatus can be configured to be compact. In this structure, particularly, the power transmitting apparatus advantageously includes a plurality of sets of the movable engagement member and the electromagnetic actuator.

In the power transmitting apparatus, the actuator shaft and the movable shaft may be respectively movable in a moving direction of the movable engagement member. The actuator shaft and the movable shaft may be offset from each other in a direction orthogonal to the moving direction of the movable engagement member. Thus, it is possible to smoothly move the movable engagement member and to flexibly dispose the electromagnetic actuator within the lubricating medium reservoir.

The power transmitting apparatus may further include bearings that supports both end portions of the movable shaft. Thus, it is possible to prevent the actuator shaft from inclining and to smoothly move the actuator shaft or the movable engagement member.

The movable engagement member and the movable shaft may be connected with each other via a connecting member. The connecting member may be formed so that a size of a portion secured to the movable shaft is larger than a size of a portion secured to the movable engagement member. Thus, rigidity of a securing portion between the movable shaft and the connecting member can be increased, thereby preventing the movable shaft from inclining and smoothly moving the movable shaft. In this structure, particularly, the movable engagement member is advantageously formed as a relatively thin ring-shaped member.

In the power transmitting apparatus, the elements may include two power input elements and one power output element. The power from the two power input elements may be selectively transmitted to the power output element. The power transmitting apparatus may be a transmission capable of selectively transmitting power from the two power input elements at predetermined respective speed ratios to the power output element. For example, such a transmission may includes a first change-speed differential rotation mechanism configured to have an input element connected with a first power output source, an output element connected with the power output element, and a fixable element and to allow differential rotations of the three elements, a second change-speed differential rotation mechanism configured to have an input element connected with a second power output source, an output element connected with the power output element, and a fixable element and to allow differential rotations of the three elements. The transmission may further includes a first fixation device configured to fix the fixable element of the first change-speed differential rotation mechanism in a non-rotatable manner, and a second fixation device configured to fix the fixable element of the second change-speed differential rotation mechanism in a non-rotatable manner. The transmission may further include a change-speed connecting-disconnecting device configured to allow a connection between the output element and the fixable element in either one of the first change-speed differential rotation mechanism and the second change-speed differential rotation mechanism and a release of the connection. Further, the power transmitting apparatus may includes two power input elements, one power output element, a first movable engagement member capable of engaging with both one of the two power input elements and the power output element, a second movable engagement member capable of engaging with both the other of the two power input elements and the power output element, an electromagnetic actuator connected with the first movable engagement member, and a second electromagnetic actuator connected with the second movable engagement member.

In the power transmitting apparatus, the elements may include one power input element and two power output elements. The power from the power input element may be selectively transmitted to the two power output elements. The power transmitting apparatus may includes one power input element, two power output elements, a first movable engagement member capable of engaging with both the power input element and one of the two power output elements, a second movable engagement member capable of engaging with both the power input elements and the other of two power output elements, an electromagnetic actuator connected with the first movable engagement member, and a second electromagnetic actuator connected with the second movable engagement member.

### BRIEF DESCRIPTION OF THE DRAWINGS

FIG. 1 is a schematic block diagram of a hybrid vehicle 20 including a transmission 60 that is a power transmitting apparatus according to one embodiment of the invention;

FIG. 2 is a schematic block diagram of the transmission 60;

FIG. 3 is an explanatory view exemplifying a state of torques and rotational speeds of primary elements included in a power distribution integration mechanism 40 and the transmission 60 when a change speed state of the transmission 60 is changed in accordance with a vehicle speed change during a drive of the hybrid vehicle 20 with an engagement of a clutch C0 and an operation of an engine 22;

FIG. 4 is a similar explanatory view to FIG. 3;

FIG. 5 is a similar explanatory view to FIG. 3;

FIG. 6 is a similar explanatory view to FIG. 3;

FIG. 7 is a similar explanatory view to FIG. 3;

FIG. 8 is a similar explanatory view to FIG. 3;

FIG. 9 is an explanatory view exemplifying an alignment chart showing a state of torques and rotational speeds of elements included in the power distribution integration mechanism 40 and a reduction gear mechanism 50 when a motor MG1 is operated as a generator and a motor MG2 is operated as a motor;

FIG. 10 is an explanatory view exemplifying an alignment chart showing a state of torques and rotational speeds of elements included in the power distribution integration mechanism 40 and a reduction gear mechanism 50 when a motor MG1 is operated as the motor and a motor MG2 is operated as the generator;

FIG. 11 is an explanatory view for explaining a motor drive mode of the hybrid vehicle 20;

FIG. 12 is a schematic block diagram of a transmission 60A according to a modified example;

FIG. 13 is a schematic block diagram of an electromagnetic actuator 101A according to a modified example;

FIG. 14 is a schematic block diagram of a clutch 200 in a modified example of the power transmitting apparatus according to the invention; and

FIG. 15 is a schematic block diagram of a clutch 300 in a modified example of the power transmitting apparatus according to the invention.

### BEST MODES OF CARRYING OUT THE INVENTION

One mode of carrying out the invention is discussed below as a preferred embodiment.

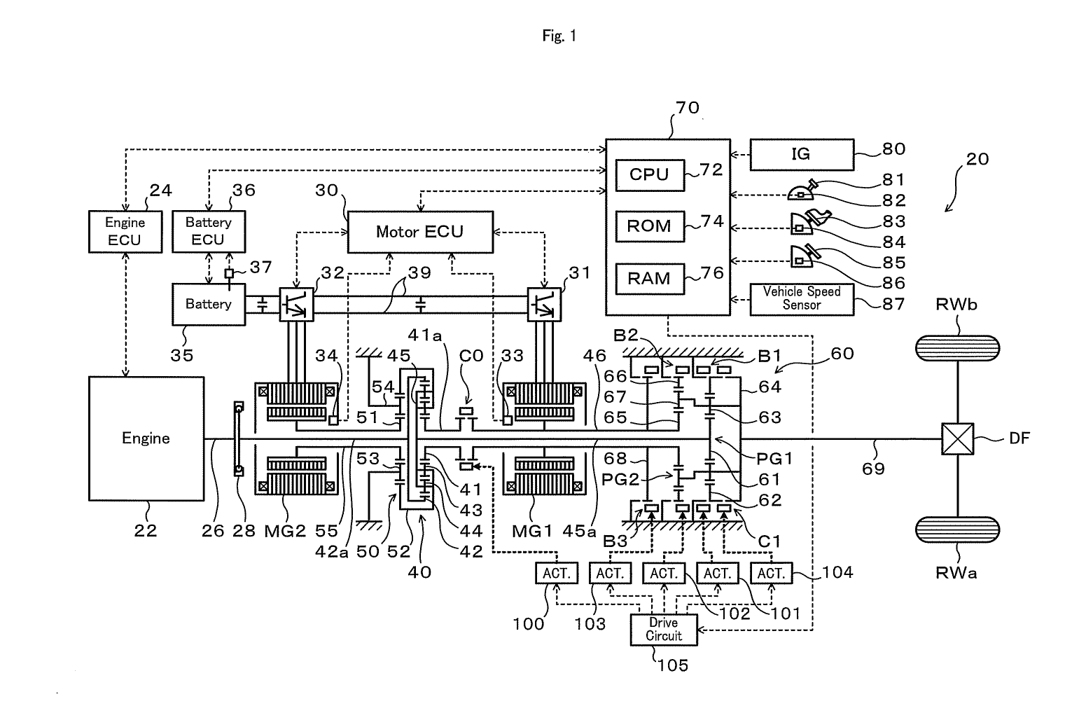

FIG. 1 is a schematic block diagram of a hybrid vehicle 20 including a transmission 60 that is a power transmitting apparatus according to one embodiment of the invention. The hybrid vehicle 20 shown in FIG. 1 is constructed as, for example, a rear-wheel drive vehicle and includes an engine 22 located in a front portion of the vehicle body, a power distribution integration mechanism 40 connected to a crankshaft (engine shaft) 26 of the engine 22, a motor MG1 having power generation capability and linked with the power distribution integration mechanism 40, a motor MG2 having power generation capability and linked with the power distribution integration mechanism 40 via a reduction gear mechanism 50 to be coaxial with the motor MG1, a transmission 60 that transmits power from the power distribution integration mechanism 40 to a driveshaft while changing a rotational speed, and a hybrid electronic control unit (hereafter referred to as ‘hybrid ECU’) 70 configured to control operations of the whole hybrid vehicle 20.

The engine 22 is an internal combustion engine that receives a supply of a hydrocarbon fuel, such as gasoline or light oil, and outputs power. The engine 22 is under control of an engine electronic control unit (hereafter referred to as ‘engine ECU’) 24 and is subjected to, for example, a fuel injection control, an ignition control, and an intake air control. The engine ECU 24 inputs diverse signals from various sensors that are provided for the engine 22 to measure and detect operating states of the engine 22, for example, a crank position sensor (not shown) mounted on the crankshaft 26. The engine ECU 24 establishes communication with the hybrid ECU 70 to drive and control the engine 22 in response to control signals from the hybrid ECU 70 and with reference to the diverse signals from the various sensors and to output data regarding the operating states of the engine 22 to the hybrid ECU 70 according to the requirements.

The motors MG1 and MG2 are constructed as synchronous motor generators of an identical specification that can be operated both as a generator and as a motor. The motors MG1 and MG2 receive and supply electric power to a battery 35 or a secondary cell via inverters 31 and 32. Power lines 39 connecting the battery 35 with the inverters 31 and 32 are structured as a common positive bus and a negative bus shared by the inverters 31 and 32. Such connection enables electric power generated by one of the motors MG1 and MG2 to be consumed by the other motor MG2 or MG1. The battery 35 may thus be charged with surplus electric power generated by either of the motors MG1 and MG2, while being discharged to supplement insufficient electric power. The battery 35 is neither charged nor discharged upon the balance of the input and output of electric powers between the motors MG1 and MG2. Both the motors MG1 and MG2 are driven and controlled by a motor electronic control unit (hereafter referred to as ‘motor ECU’) 30. The motor ECU 30 inputs various signals required for driving and controlling the motors MG1 and MG2, for example, signals representing rotational positions of rotors in the motors MG1 and MG2 from rotational position detection sensors 33 and 34 and signals representing phase currents to be applied to the motors MG1 and MG2 from current sensors (not shown). The motor ECU 30 outputs switching control signals to the inverters 31 and 32. The motor ECU 30 executes a rotational speed computation routine (not shown) to compute rotational speeds Nm1 and Nm2 of the rotors of the motors MG1 and MG2 from the signals output from the rotational position detection sensors 33 and 34. The motor ECU 30 establishes communication with the hybrid ECU 70 to drive and control the motors MG1 and MG2 in response to control signals received from the hybrid ECU 70 and to output data regarding operating states of the motors MG1 and MG2 to the hybrid ECU 70 according to the requirements.

The battery 35 is under control and management of a battery electronic control unit (hereafter referred to as ‘battery ECU’) 36. The battery ECU 36 inputs various signals required for management and control of the battery 35, for example, an inter-terminal voltage from a voltage sensor (not shown) located between terminals of the battery 35, a charge-discharge current from a current sensor (not shown) located in the power line 39 connecting with an output terminal of the battery 35, and a battery temperature Tb from a temperature sensor 37 attached to the battery 35. The battery ECU 36 outputs data regarding operating states of the battery 35 by communication to the hybrid ECU 70 and to the engine ECU 24 according to the requirements. In the embodiment, the battery ECU 36 calculates a remaining charge amount or a state of charge SOC of the battery 35 based on an integrating value the charge-discharge current measured by the current sensor and calculates a charge-discharge power demand Pb* of the battery 35 based on the computed state of charge SOC. The battery ECU 36 also sets an input limit Win as an allowable charging power to be charged into the battery 35 and an output limit Wout as an allowable discharging power to be discharged from the battery 35, based on the computed state of charge SOC and the measured battery temperature Tb. The input and output limits Win and Wout of the battery 35 are set by setting base values depending on the battery temperature Tb and setting an input limit correction coefficient and an output limit correction coefficient based on the state of charge SOC of the battery 50, and then multiplying the set base value of the input and output limits Win and Wout by the set correction coefficient.

The power distribution integration mechanism 40 is housed in a non-illustrated transmission case (casing) together with the motors MG1 and MG2, the reduction gear mechanism 50 and the transmission 60. The power distribution integration mechanism 40 is arranged apart from the engine 22 by a predetermined distance to be coaxial with the crankshaft 26. The power distribution integration mechanism 40 of the embodiment is a double pinion planetary gear mechanism and includes a sun gear 41 that is an external gear, a ring gear 42 that is an internal gear arranged concentrically with the sun gear 41, and a carrier 45 that supports at least one set of two pinion gears 43 and 44 intermeshing with each other so as to allow both their revolutions and their rotations on their axes. One of the two pinion gears 43 and 44 engages with the sun gear 41 and the other engages with the ring gear 42. In this power distribution integration mechanism 40, the sun gear 41 (second element), the ring gear 42 (third element), and the carrier 45 (first element) are designed as elements of differential rotations. In the embodiment, the power distribution integration mechanism 40 is constructed to have a gear ratio ρ (quotient of the number of teeth of the sun gear 41 divided by the number of teeth of the ring gear 42) satisfying a relation of ρ<0.5. The sun gear 41 or the second element of the power distribution integration mechanism 40 is connected with the motor MG1 (more specifically with its hollow rotor) or a second motor via a hollow sun gear shaft 41a extended from the sun gear 41 in a direction opposite to the engine 22 (that is, toward a rear portion of the vehicle body) and a hollow first motor shaft 46. The carrier 45 or the first element is connected with the motor MG2 (more specifically with its hollow rotor) or a first motor via the reduction gear mechanism 50 located between the power distribution integration mechanism 40 and the engine 22 and a hollow second motor shaft 55 extended from the reduction gear mechanism 50 (more specially from its sun gear 51) toward the engine 22. The ring gear 42 or the third element is connected with the crankshaft 26 of the engine 22 via a ring gear shaft 42a extended to pass through the second motor shaft 55 and the motor MG2, as well as a damper 28.

As shown in FIG. 1, a clutch C0 (connecting-disconnecting device) is disposed between the sun gear shaft 41a and the first motor shaft 46. The clutch C0 is configured to allow a connection (drive source-element connection) between the sun gear shaft 41a and the first motor shaft 46 and a release of the connection. The clutch C0 of the embodiment is a dog clutch driven by an electromagnetic actuator 100. When the connection between the sun gear shaft 41a and the first motor shaft 46 is released by the clutch C0, connection between the motor MG1 or the second motor and the sun gear 41 or the second element of the power distribution integration mechanism 40, so that the engine 22 can be substantially separated from the motors MG1 and MG2 and the transmission 60 by the function of the power distribution integration mechanism 40. The first motor shaft 46 that can be connected with the sun gear 41 of the power distribution integration mechanism 40 via the clutch C0 is further extended from the motor MG1 in the direction opposite to the engine 22 (toward the rear portion of the vehicle body) and is connected with the transmission 60. A carrier shaft (coupling shaft) 45a is extended from the carrier 45 of the power distribution integration mechanism 40 in the direction opposite to the engine 22 (toward the rear portion of the vehicle body). The carrier shaft 45a passes through the hollow sun gear shaft 41a and the hollow first motor shaft 46, and is connected with the transmission 60. Thus, in the embodiment, the power distribution integration mechanism 40 is arranged coaxially with the motors MG1 and MG2 and is located between the motors MG1 and MG2 coaxially arranged with each other. Further, the engine 22 is arranged coaxially with the motor MG2 and is located to oppose the transmission 60 across the power distribution integration mechanism 40. The engine 22, the motor MG2, (the reduction gear mechanism 50), the power distribution integration mechanism 40, the motor MG1, and the transmission 60 as the constituents of the power output apparatus are thus arranged in this sequence from the forward to the rearward of the vehicle body. This arrangement reduces the size of the power output apparatus to be suitable for mounting on the rear-wheel drive hybrid vehicle 20.

The reduction gear mechanism 50 is a single pinion planetary gear mechanism and includes a sun gear 51 that is an external gear, a ring gear 52 that is an internal gear arranged concentrically with the sun gear 51, multiple pinion gears 53 arranged to engage with the sun gear 51 and with the ring gear 52, and a carrier 54 arranged to support the multiple pinion gears 53 so as to allow both their revolutions and their rotations on their axes. The sun gear 51 of the reduction gear mechanism 50 is connected with the rotor of the motor MG2 via the second motor shaft 55. The ring gear 52 of the reduction gear mechanism 50 is secured to the carrier 45 of the power distribution integration mechanism 40, so that the reduction gear mechanism 50 is substantially integrated with the power distribution integration mechanism 40. The carrier 54 of the reduction gear mechanism 50 is fixed to the transmission case of the transmission 60. The function of the reduction gear mechanism 50 reduces the speed of power from the motor MG2 to be input into the carrier 45 of the power distribution integration mechanism 40, while increasing the speed of the output power from the carrier 45 to be input into the motor MG2. In the power distribution integration mechanism 40 or the double pinion planetary gear mechanism having the gear ratio ρ of less than 0.5, the engine 22 has a large torque distribution rate to the carrier 45 in comparison with the sun gear 41. The arrangement of the reduction gear mechanism 50 between the carrier 45 of the power distribution integration mechanism 40 and the motor MG2 downsizes the motor MG2 and reduces a power loss of the motor MG2. The arrangement of the reduction gear mechanism 50 between the motor MG2 and the power distribution integration mechanism 40 to be integrated with the power distribution integration mechanism 40 enables further size reduction of the power output apparatus. In the embodiment, the reduction gear mechanism 50 is constructed to have a reduction gear ratio (number of teeth of the sun gear 51/number of teeth of the ring gear 52) set to a value close to ρ/(1−ρ), where ρ represents the gear ratio of the power distribution integration mechanism 40. The motors MG1 and MG2 can thus be constructed to have substantially identical specifications. This arrangement effectively improves the productivity of the hybrid vehicle 20 and the power output apparatus and reduces the manufacturing cost of the hybrid vehicle 20 and the power output apparatus.

The transmission 60 is a planetary gear-type automatic transmission capable of setting its speed ratio at multiple different stages. The transmission 60 includes a first change speed planetary gear mechanism PG1 (first change speed differential rotation mechanism) connected via the carrier shaft 45a with the carrier 45 or the first element of the power distribution integration mechanism 40, a second change speed planetary gear mechanism PG2 (second change speed differential rotation mechanism) connected with the first motor shaft 46 connectable via the clutch C0 with the sun gear 41 or the second element of the power distribution integration mechanism 40, a brake B1 (first fixation device) corresponding to the first change speed planetary gear mechanism PG1, a brake B2 (second fixation device) corresponding to the second change speed planetary gear mechanism PG2, a brake B3 (third fixation device) and a clutch C1 (change-speed connecting-disconnecting device).

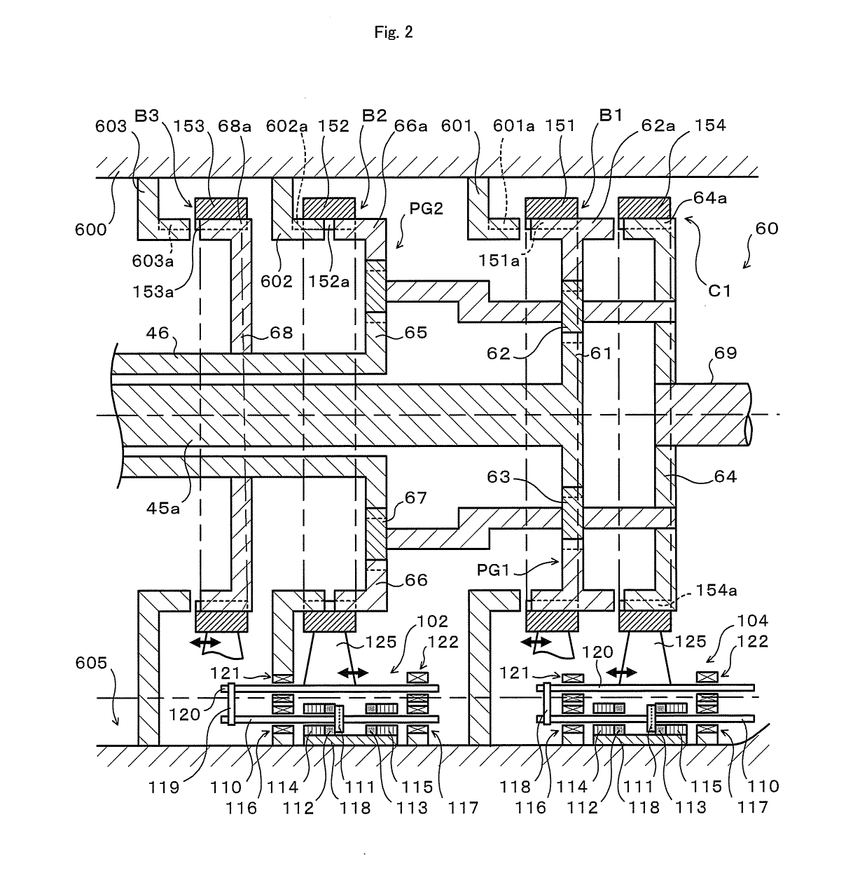

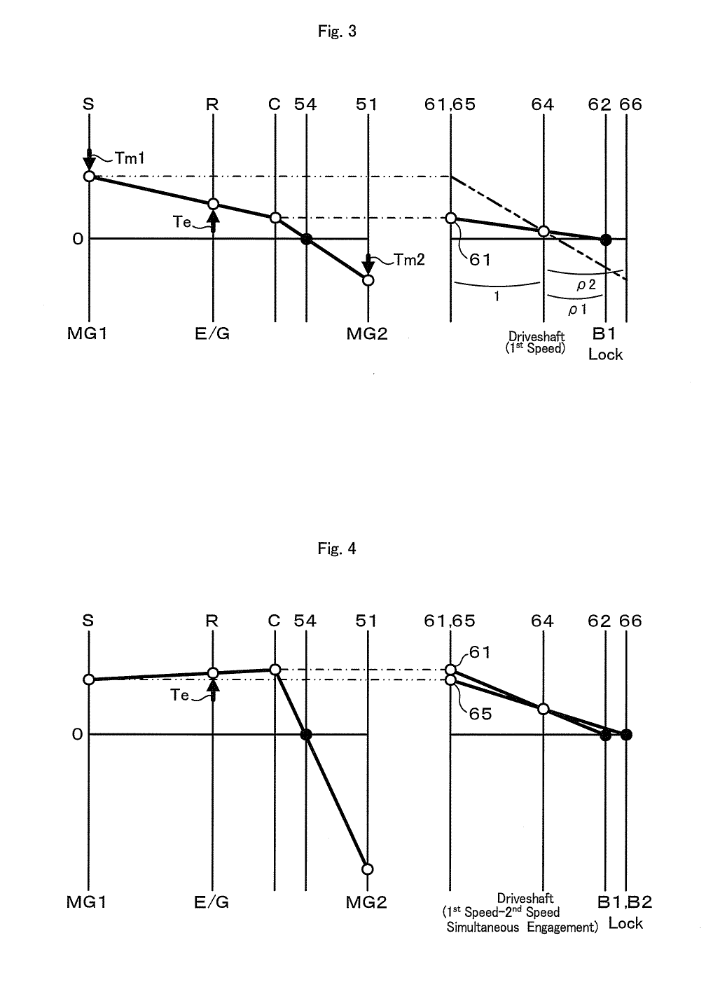

As shown in FIGS. 1 and 2, the first change speed planetary gear mechanism PG1 is a single pinion planetary gear mechanism and includes a sun gear 61 connected with the carrier shaft 45a, a ring gear 62 that is an internal gear arranged coaxially with the sun gear 61, and a carrier 64 arranged to hold multiple pinion gears 63 engaging with both the sun gear 61 and the ring gear 62 and connected with the driveshaft 69. The sun gear 61 (input element), the ring gear 62 (fixable element), and the carrier 64 (output element) are designed as elements of differential rotations. The second change speed planetary gear mechanism PG2 is also a single pinion planetary gear mechanism and includes a sun gear 65 connected with the first motor shaft 46, a ring gear 66 that is an internal gear arranged coaxially with the sun gear 65, and the common carrier 64 that is shared with the first change speed planetary gear mechanism PG1 and holds multiple pinion gears 67 engaging with both the sun gear 65 and the ring gear 66. The sun gear 65 (input element), the ring gear 66 (fixable element), and the carrier 64 (output element) are designed as elements of differential rotations. In the embodiment, the second change speed planetary gear mechanism PG2 is arranged to be coaxial with and ahead of the first change speed planetary gear mechanism PG1 in the vehicle body. A gear ratio ρ2 (number of teeth of the sun gear 65/number of teeth of the ring gear 66) of the second change speed planetary gear mechanism PG2 is set to be slightly larger than a gear ratio ρ1 (number of teeth of the sun gear 61/number of teeth of the ring gear 62) of the first change speed planetary gear mechanism PG1 (See FIG. 3). Constituents of the first change speed planetary gear mechanism PG1, the second change speed planetary gear mechanism PG2, the brakes B1-B3 and the clutch C1 are housed in the transmission case (casing) 600 of the transmission 60. The power transmitted from the carrier of the transmission 60 to the driveshaft 69 is eventually output through a differential gear DF to rear wheels RWa and RWb or drive wheels. The transmission 60 of the above structure enables significant size reduction both in the axial direction and in a radial direction in comparison with the parallel shaft-type transmission. The first and second change speed planetary gear mechanisms PG1 and PG2 can be arranged coaxially with and in the downstream of the engine 22, the motors MG1 and MG2, the reduction gear mechanism 50, and the power distribution integration mechanism 40. The transmission 60 constructed as described above desirably simplifies the bearing structure and reduces the number of bearings.

The brake B1 is a dog clutch including a movable engagement member 151 and an electromagnetic actuator 101 to move the movable engagement member 151 back and forth in the axial direction of the carrier shaft 45a and the first motor shaft 46. The brake B1 is capable of fixing the ring gear 62 of the first change speed planetary gear mechanism PG1 to the transmission case 600 in a non-rotatable manner and releasing the ring gear 62 in a rotatable manner. In the embodiment, the movable engagement member 151 is a relatively thin ring-shaped member having tooth portions 151a capable of engaging with both splines 62a formed on an outer periphery of the ring gear 62 and splines 601a formed on a tip of a locking member 601 having a ring-shape in the embodiment and secured to an inner surface of the transmission case 600. The brake B2 is a dog clutch including a movable engagement member 152 and an electromagnetic actuator 102 to move the movable engagement member 152 back and forth in the axial direction of the carrier shaft 45a and the first motor shaft 46. The brake B2 is capable of fixing the ring gear 66 of the second change speed planetary gear mechanism PG2 to the transmission case 600 in a non-rotatable manner and releasing the ring gear 66 in a rotatable manner. In the embodiment, the movable engagement member 152 is a relatively thin ring-shaped member having tooth portions 152a capable of engaging with both splines 66a formed on an outer periphery of the ring gear 66 and splines 602a formed on a tip of a locking member 602 having a ring-shape in the embodiment and secured to the inner surface of the transmission case 600. The brake B3 is a dog clutch including a movable engagement member 153 and an electromagnetic actuator 103 to move the movable engagement member 153 back and forth in the axial direction of the carrier shaft 45a and the first motor shaft 46. The brake B3 is capable of fixing the first motor shaft 46 or the sun gear 41 that is the second element of the power distribution integration mechanism 40 to the transmission case 600 in a non-rotatable manner via a fixing member 68 secured to the first motor shaft 46 and releasing the fixing member 68 so as to allow the first motor shaft 46 to rotate. In the embodiment, the movable engagement member 153 is a relatively thin ring-shaped member having tooth portions 153a capable of engaging with both splines 68a formed on an outer periphery of the fixing member 68 and splines 603a formed on a tip of a locking member 603 having a ring-shape in the embodiment and secured to an inner surface of the transmission case 600. The clutch C1 is a dog clutch including a movable engagement member 154 and an electromagnetic actuator 104 to move the movable engagement member 154 back and forth in the axial direction of the carrier shaft 45a and the first motor shaft 46. The clutch C1 is capable of a connection between the carrier 64 or the output element of the first and second change speed planetary gear mechanisms PG1 and PG2 the ring gear 62 or the fixable element of the planetary gear mechanisms PG1 and PG2 and a release of the connection. In the embodiment, the movable engagement member 154 is a relatively thin ring-shaped member having tooth portions 154a capable of engaging with both splines 62a formed on the outer periphery of the ring gear 62 and splines 64a formed on an outer periphery of the carrier 64. Although a detailed description thereof is omitted, the above clutch C0 is a dog clutch similar to the clutch C1.

The above electromagnetic actuators 100-104 of the brakes B1-B3, the clutches C0 and C1 have basically same construction and are disposed within an oil pan 605 that is defined in a lower portion of the transmission case 600 and stores a transmission oil for lubricating and cooling the constituents of the transmission 60. The construction of the electromagnetic actuators 100-104 will be explained as follow while taking the electromagnetic actuator 102 as an example. As shown in FIG. 2, the electromagnetic actuator 102 includes an actuator shaft 110 connected with the movable engagement member 152 and movable in a predetermined direction, a permanent magnet 111 secured to the actuator shaft 110, a couple of fixed magnetic poles 112 and 113 arranged so that the permanent magnet 111 is positioned between the fixed magnetic poles 112 and 113, a coil 114 connected with the fixed magnetic poles 112, and a coil 115 connected with the fixed magnetic poles 113. The actuator shaft 110 is inserted into hole portions of the fixed magnetic poles 112 and 113. Both ends of the actuator shaft 110 are slidably supported by bearings 116 and 117 that are disposed on the outside of the fixed magnetic poles 112 and the coil 114 or the outside of the fixed magnetic poles 113 and the coil 115. The actuator shaft 110 extends in parallel with the carrier shaft 45a and the first shaft 46. In the embodiment, the bearing 116 on the left side in FIG. 2 is held by a base end portion of the locking member 602 and the bearing 117 on the right side in FIG. 2 is secured to a surface of the oil pan 605. It may be possible to provide a function of the bearing to one of the fixed magnetic poles 112 and 113 and the coils 114 and 115 and the bearing 117 on the right side in FIG. 2, for example, may be omitted. The permanent magnet 111 is formed in a disk-shape for example. The permanent magnet 11 is secured to the actuator shaft 110 so that it is positioned between the fixed magnetic poles 112 and 113 and a polarity of the permanent magnet 111 in the side of the fixed magnetic pole 112 and that in the side of the fixed magnetic pole 113 are opposite with respect to each other (hereafter, for simplicity, the polarity of the permanent magnet 111 in the side of the fixed magnetic pole 112 is supposed to be the north pole and that in the side of the fixed magnetic pole 113 is supposed to be the south pole). The fixed magnetic poles 112 and 113 and the coils 114 and 115 are mounted on a base plate 118 that is secured to the surface of the oil pan 605. The coils 114 and 115 are electrically connected to a drive circuit 105 (see FIG. 1) that is configured to individually apply voltage to the coils 114 and 115 of the electromagnetic actuators 100-104 so as to change polarities of each of the coils 114 and 115. An movable shaft 120 is connected to one end (left end in the figure) of the actuator shaft 110 via a connecting rod 119. As shown in FIG. 2, both ends of the movable shaft 120 are slidably supported by a bearing 121 that is held by the locking member 602 to be positioned over the bearing 116 and a bearing 122 that is secured to an upper portion of the bearing 117. Thus, the actuator shaft 110 and the movable shaft 120 are arranged offset from each other in a top to bottom direction in the figure that is a direction orthogonal to a moving direction of the movable engagement member 152, that is, an axial direction of the carrier shaft 45a and the first motor shaft 46. The movable shaft 120 is secured to the movable engagement member 152 via a connecting member 125. In the embodiment, the connecting member 125 has a trapezoid-shaped cross-section in which a lower base length is longer than an upper base length. The connecting member 125 is secured to the movable engagement member 152 in the side of the upper base and is secured to the movable shaft 120 in the side of the lower length. That is, the connecting member 125 is formed so that a size of a portion secured to the movable shaft 120 is larger than a size of a portion secured to the movable engagement member 152.

According to the electromagnetic actuators 100-104, it is possible to release a magnetic coupling between the permanent magnet 111 and one of the fixed magnetic poles 112 and 113 and to move the actuator shaft 110 and the movable shaft 120 together with the movable engagement member 152 by changing the polarities of the fixed magnetic poles 112 and 113 by means of the drive circuit 105, the coils 114 and 115, thereby capable of a connection between two elements corresponding to the brakes B1-B3 and clutches C1 and C0 and a release of the connection. When the permanent magnet 111 magnetically couples with the other of the fixed magnetic poles 112 and 113, it is possible to readily and reliably retain the connection between the two elements by means of the movable engagement member 152 even if a setting of the polarity of each of the fixed magnetic poles 112 and 113 by means of the drive circuit 105, the coils 114 and 115 is released. For example, repulsive force releases a magnetic coupling between the permanent magnet 111 and the fixed magnetic pole 112 on the left side by applying voltage to the coils 114 and 115 of the electromagnetic actuator 102 from the drive circuit 150 so as to set both polarities of the fixed magnetic poles 112 and 113 to the north pole when the permanent magnet 111 magnetically couples with the fixed magnetic pole 112 as shown in FIG. 2 and the ring gear 66 is fixed to the transmission case 600 in the non-rotatable manner via the locking member 602 by the brake B2. Then, the permanent magnet 111 and the fixed magnetic pole 113 attract each other, so that the actuator shaft 110 and the movable shaft 120 moves on the right side in the figure and the permanent magnet 111 magnetically couples with the fixed magnetic pole 113. The permanent magnet 111 keeps on magnetically coupling with the fixed magnetic pole 113 by magnetic force thereof even if an application of the voltage from the drive circuit 105 to the coils 114 and 115 is released. The movable engagement member 152 moves on the right side in the figure in response to the movement of the movable shaft 120 that is secured to the movable engagement member 152, so that the ring gear 66 is released from the locking member 602 to be rotatable and a release state of the ring gear 66 is retained by the magnetic coupling between the permanent magnet 111 and the fixed magnetic pole 113. Repulsive force releases a magnetic coupling between the permanent magnet 111 and the fixed magnetic pole 113 on the right side by applying voltage to the coils 114 and 115 of the electromagnetic actuator 102 from the drive circuit 150 so as to set both polarities of the fixed magnetic poles 112 and 113 to the south pole when an engagement between the ring gear 66 and the locking member 602. Then, the permanent magnet 111 and the fixed magnetic pole 112 attract each other, so that the actuator shaft 110 and the movable shaft 120 moves on the left side in the figure and the permanent magnet 111 magnetically couples with the fixed magnetic pole 112. Thus, the movable engagement member 152 moves on the left side in the figure in response to the movement of the movable shaft 120 that is secured to the movable engagement member 152, so that the ring gear 66 engages with the locking member 602 to be non-rotatable and a non-rotatable state of the ring gear 66 is retained by the magnetic coupling between the permanent magnet 111 and the fixed magnetic pole 112. It is possible to operate the brakes B1, B2, clutches C0 and C1 as described above by actuating the electromagnetic actuator 100, 101, 103 and 104 in accordance with procedure similar to the above described one.

The hybrid ECU 70 is constructed as a microprocessor including a CPU 72, a ROM 74 that stores processing programs, a RAM 76 that temporarily stores data, a non-illustrated input-output port, and a non-illustrated communication port. The hybrid ECU 70 receives various inputs via the input port: an ignition signal from an ignition switch (start switch) 80, a shift position SP from a shift position sensor 82 that detects the current position of a shift lever 81, an accelerator opening Acc from an accelerator pedal position sensor 84 that measures a depression amount of an accelerator pedal 83, a brake pedal position BP from a brake pedal position sensor 86 that measures a depression amount of a brake pedal 85, and a vehicle speed V from a vehicle speed sensor 87. The hybrid ECU 70 communicates with the engine ECU 24, the motor ECU 30, and the battery ECU 36 via the communication port to transmit diverse control signals and data to and from the engine ECU 24, the motor ECU 30, and the battery ECU 36, as mentioned previously. The hybrid ECU 70 also controls the drive circuit 105 that applies voltage to the coils 114 and 115 of the electromagnetic actuators 100-104 of the clutch C0, the brakes B1-B3 and the clutch C1 includes in the transmission 60.

Operations of the hybrid vehicle 20 are described below with reference to FIGS. 3 through 11. During a drive of the hybrid vehicle 20 in respective change speed states of FIGS. 3 to 9, under comprehensive control of the hybrid ECU 70 based on the driver's depression amount of an accelerator pedal 83 and the vehicle speed V, the engine 22 is controlled by the engine ECU 24, the motors MG1 and MG2 are controlled by the motor ECU 30, and the electromagnetic actuators 100 to 104 (the clutch C0, the brakes B1-B3 and the clutch C1 of the transmission 60) are directly controlled by the hybrid ECU 70. In FIGS. 3 through 8, an S-axis represents a rotational speed of the sun gear 41 in the power distribution integration mechanism 40 (equivalent to a rotational speed Nm1 of the motor MG1 or the first motor shaft 46). An R-axis represents a rotational speed of the ring gear 42 in the power distribution integration mechanism 40 (equivalent to a rotational speed Ne of the engine 22). A C-axis represents a rotational speed of the carrier 45 in the power distribution integration mechanism 40 (equivalent to a rotational speed of the carrier shaft 45a and the ring gear 52 of the reduction gear mechanism 50). A 54-axis represents a rotational speed of the carrier 54 of the reduction gear mechanism 50, and a 51-axis represents a rotational speed of the sun gear 51 of the reduction gear mechanism 50 (equivalent to a rotational speed Nm2 of the motor MG2 or the second motor shaft 55). A 61, 65-axis represents a rotational speed of the sun gear 61 in the first change speed planetary gear mechanism PG1 and a rotational speed of the sun gear 65 in the second change speed planetary gear mechanism PG2 in the transmission 60. A 64-axis represents a rotational speed of the carrier 64 in the transmission 60 (equivalent to a rotational speed of the driveshaft 69). A 62-axis represents a rotational speed of the ring gear 62 in the first change speed planetary gear mechanism PG1. A 66-axis represents a rotational speed of the ring gear 66 in the second change speed planetary gear mechanism PG2.

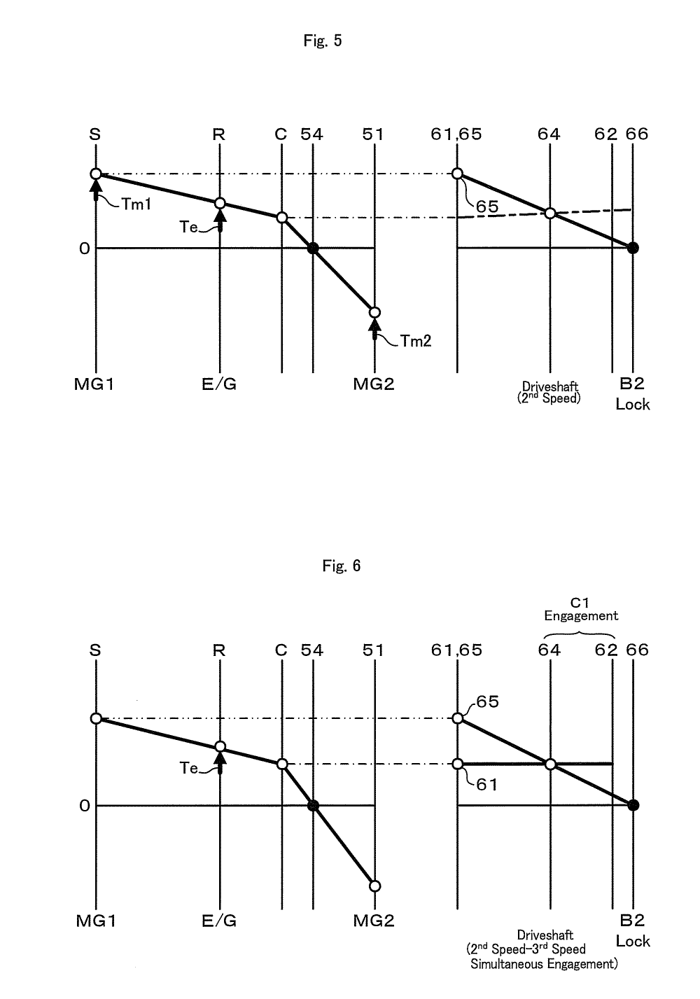

During a drive of the hybrid vehicle 20 with an engagement of the clutch C0 and an operation of the engine 22, the transmission 60 can be set in a first change speed state (first speed) by fixing the ring gear 62 of the first change speed planetary gear mechanism PG1 to the transmission case 600 in the non-rotatable manner by the brake B1 as shown in FIG. 3. In the first change speed state, the power from the carrier shaft 45a (the carrier 45) is subjected to speed change at a speed ratio (=ρ1/(1+ρ1)) based on the gear ratio ρ1 of the first change speed planetary gear mechanism PG1 and is transmitted to the driveshaft 69. When the rotational speed of the ring gear 66 in the second change speed planetary gear mechanism PG2 changes from a negative value to almost 0 in response to a decrease of the rotational speed Nm1 of the motor MG1 (the sun gear 41 and the first motor shaft 46) in the first change speed state of FIG. 3, the ring gear 66 or the fixable element of the second change speed planetary gear mechanism PG2 may be fixed in the non-rotatable manner as shown in FIG. 4 while fixing the ring gear 62 of the first change speed planetary gear mechanism PG1 in the non-rotatable manner. Hereafter, a mode of fixing both the ring gear 62 in the first change speed planetary gear mechanism PG1 and the ring gear 66 in the second change speed planetary gear mechanism PG2 in the non-rotatable manner by means of the brakes B1 and B2 is referred to as ‘simultaneous engagement mode’. The state of FIG. 4 is specifically called ‘1^{st} speed-2^{nd} speed simultaneous engagement state’. Setting torque commands of the motors MG1 and MG2 to 0 in the 1^{st} speed-2^{nd} speed simultaneous engagement state causes the motors MG1 and MG2 to run idle without performing either power operation or regenerative operation. Power (torque) from the engine 22 is thus mechanically (directly) transmitted at a fixed (constant) speed ratio (a value between the speed ratio of the first change speed state and the speed ratio of a second change speed state) to the driveshaft 69 without conversion into electrical energy. When the brake B2 is released so that the ring gear 62 of the first change speed planetary gear mechanism PG1 is in the rotatable manner while non-rotatably fixing the ring gear 66 of the second change speed planetary gear mechanism PG2 in the 1^{st} speed-2^{nd} speed simultaneous engagement state of FIG. 4, the transmission 60 is set in a second change speed state (second speed) as shown in FIG. 5. In the second change speed state, power from the first motor shaft 46 is subjected to speed change at a speed ratio (=ρ2/(1+ρ2)) based on the gear ratio ρ2 of the second change speed planetary gear mechanism PG2 and is transmitted to the driveshaft 69.

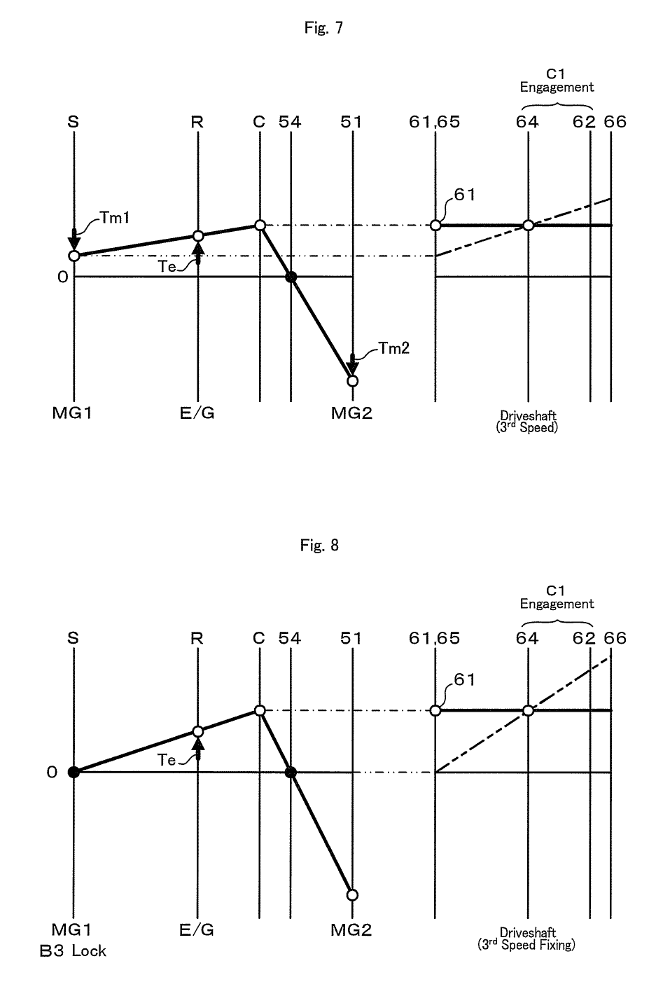

When the rotational speeds of the sun gear 61, the ring gear 62, and the carrier 64 of the first change speed planetary gear mechanism PG1 are almost equal to one another to allow substantially integral rotation of these elements 61, 62, and 64 in the second change speed state of FIG. 5, the ring gear 62 of the first change speed planetary gear mechanism PG1 may be coupled with the carrier 64 by the clutch C1 as shown in FIG. 6. Hereafter, a mode of coupling the ring gear 62 of the first change speed planetary gear mechanism PG1 with the carrier 64 by means of the clutch C1 while fixing the ring gear 66 of the second change speed planetary gear mechanism PG2 in the non-rotatable manner by means of the brake B2 is also referred to as the ‘simultaneous engagement mode’. The state of FIG. 6 is specifically called ‘2^{nd} speed-3^{rd} speed simultaneous engagement state’. Setting torque commands of the motors MG1 and MG2 to 0 in the 2^{nd} speed-3^{rd} speed simultaneous engagement state causes the motors MG1 and MG2 to run idle without performing either power operation or regenerative operation. Power (torque) from the engine 22 is thus mechanically (directly) transmitted at a fixed (constant) speed ratio (a value between the speed ratio of the second change speed state and the speed ratio of a third change speed state) to the driveshaft 69 without conversion into electrical energy. When the brake B2 is released so that the ring gear 66 of the second change speed planetary gear mechanism PG2 is in the rotatable manner in the 2^{nd} speed-3^{rd} speed simultaneous engagement state of FIG. 6, the transmission 60 is set in a third change speed state (third speed). In the third change speed state shown in FIG. 7, the clutch C1 substantially locks the sun gear 61, the ring gear 62, and the carrier 64 of the first change speed planetary gear mechanism PG1 to allow integral rotation of these elements 61, 62, and 64. Power from the carrier 45 of the power distribution integration mechanism 40 is thus directly transmitted at a speed ratio of “1” to the driveshaft 69 via the carrier shaft 45a and the integrally rotating elements of the first change speed planetary gear mechanism PG1 as shown in FIG. 7. In the third change speed state, a ratio of the rotational speed of the engine 22 to a rotational speed of the driveshaft 69 directly linked with the carrier 45 or the output element is varied continuously in a stepless manner by controlling the rotational speed of the motor MG1.

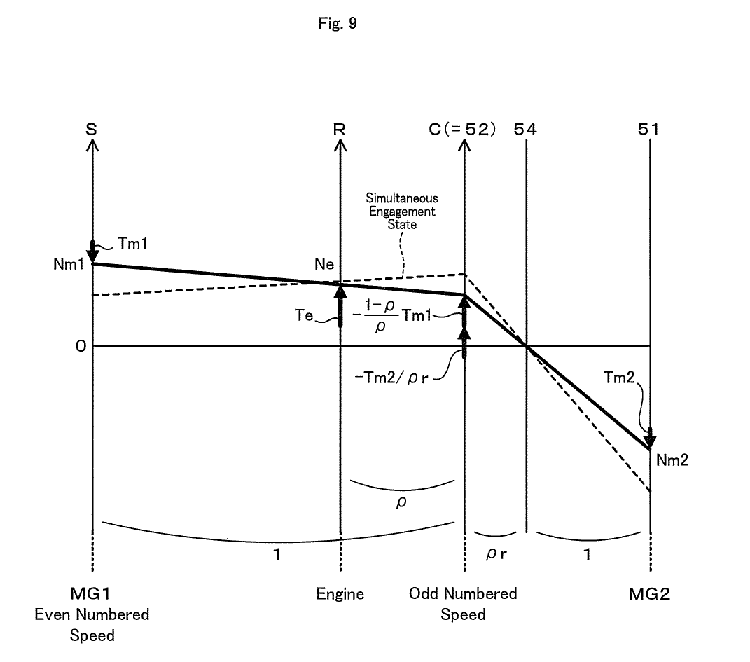

When the rotational speeds of the motor MG1, the first motor shaft 46, the sun gear 41 and the sun gear 61 of the first change speed planetary gear mechanism PG1 approach to 0 in the third change speed state of FIG. 7, the sun gear 41 or the second element of the power distribution integration mechanism 40 may be fixed in the non-rotatable manner by the brake B3 via the fixing member 68 and the first motor shaft 46 as shown in FIG. 8. Hereafter, a mode of fixing the first motor shaft 46 (the motor MG1) in the non-rotatable manner by means of the brake B3 while keeping the ring gear 62 coupled with the carrier 64 by means of the clutch C1 to substantially lock the first change speed planetary gear mechanism PG1 of the transmission 60 is also referred to as the ‘simultaneous engagement mode’. The state of FIG. 9 is specifically called ‘3^{rd} speed fixing state’. Setting the torque commands of the motors MG1 and MG2 to 0 in the 3^{rd} speed fixing state causes the motors MG1 and MG2 to run idle without performing either power operation or regenerative operation. Power (torque) from the engine 22 is thus directly transmitted to the driveshaft 69 at a fixed (constant) speed ratio (a value in an increasing speed side compared to the speed ratio of, the third change speed state) to the driveshaft 69 without conversion into electrical energy. The speed ratio of the transmission 60 may be shifted down in accordance with a procedure reverse to the above description.

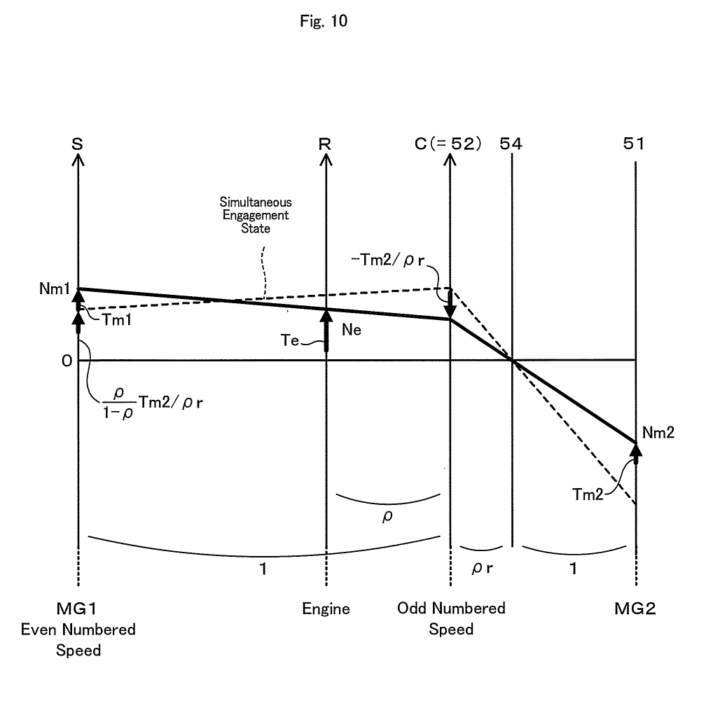

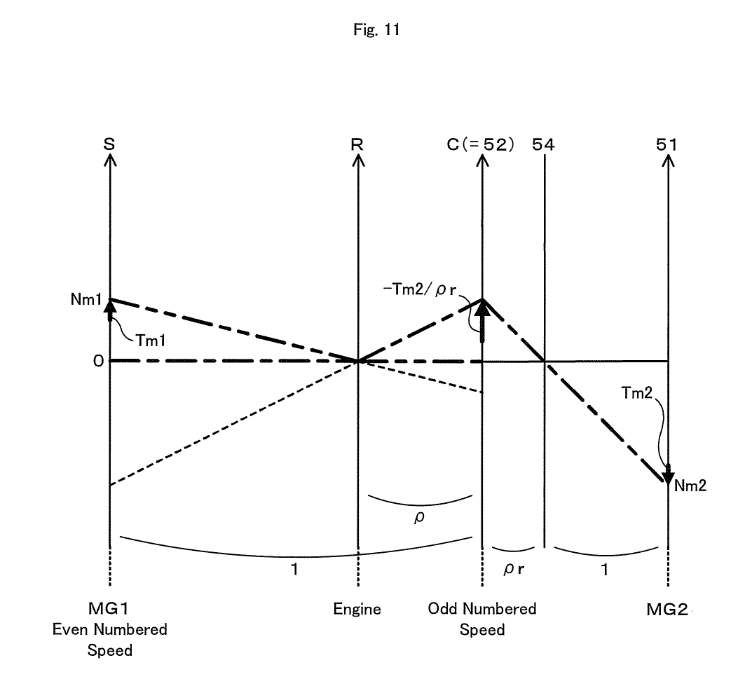

When the transmission 60 is set to either the first change speed state or the third change speed state during the drive of the hybrid vehicle 20 with the operation of the engine 22, the motors MG1 and MG2 may be driven and controlled to make the motor MG2, which is connected with the carrier 45 of the power distribution integration mechanism 40 working as the output element, function as the motor and to make the motor MG1, which is connected with the sun gear 41 working as the reactive element, function as the generator. In this state, the power distribution integration mechanism 40 distributes the power from the engine 22 input via the ring gear 42 at its gear ratio ρ into the sun gear 41 and the carrier 45, while integrating the power from the engine 22 with the power from the motor MG2 functioning as the motor and outputting the integrated power to the carrier 45. Hereafter, a mode of making the motor MG1 function as the generator and making the motor MG2 function as the motor is referred to as ‘first torque conversion mode’. In the first torque conversion mode, the power from the engine 22 goes through torque conversion by means of the power distribution integration mechanism 40 and the motors MG1 and MG2 and is then output to the carrier 45. The ratio of the rotational speed Ne of the engine 22 to the rotational speed of the carrier 45 or the output element is varied continuously in a stepless manner by controlling the rotational speed of the motor MG1. FIG. 9 is an explanatory view exemplifying an alignment chart showing a state of torques and rotational speeds of elements included in the power distribution integration mechanism 40 and the reduction gear mechanism 50 in the first torque conversion mode. The S-axis, the R-axis, and the C-axis in FIG. 9 represent the same meanings as those in FIGS. 3 through 8. The 54-axis represents the rotational speed of the carrier 54 in the reduction gear mechanism 50, and the 51-axis represents the rotational speed of the sun gear 51 in the reduction gear mechanism 50 (equivalent to the rotational speed Nm2 of the motor MG2 or the second motor shaft 55). In the alignment chart of FIG. 9, ρ denotes the gear ratio of the power distribution integration mechanism 40 (number of teeth of the sun gear 41/number of teeth of the ring gear 42), and pr denotes the reduction gear ratio of the reduction gear mechanism 50 (number of teeth of the sun gear 51/number of teeth of the ring gear 52). In FIG. 9, values above a O-axis (horizontal axis) and values below the O-axis respectively show positive rotational speeds and negative rotational speeds on the S-axis, the R-axis, the C-axis, and the 51-axis. Thick arrows on the axes represent torques applied to the corresponding elements; upward arrows show application of positive torques and downward arrows show application of negative torques. These definitions are similarly applied to the alignment charts of FIGS. 3 through 8 explained above and the alignment charts of FIGS. 10 and 11 explained later.

When the transmission 60 is set to the second change speed state during the drive of the hybrid vehicle 20 with operation of the engine 22, the motors MG1 and MG2 may be driven and controlled to make the motor MG1, which is connected with the sun gear 41 of the power distribution integration mechanism 40 working as the output element, function as the motor and to make the motor MG2, which is connected with the carrier 45 working as the reactive element, function as the generator. In this state, the power distribution integration mechanism 40 distributes the power from the engine 22 input via the ring gear 42 at its gear ratio ρ into the sun gear 41 and the carrier 45, while integrating the power from the engine 22 with the power from the motor MG1 functioning as the motor and outputting the integrated power to the sun gear 41. Hereafter, a mode of making the motor MG2 function as the generator and making the motor MG1 function as the motor is referred to as ‘second torque conversion mode’. In the second torque conversion mode, the power from the engine 22 goes through torque conversion by means of the power distribution integration mechanism 40 and the motors MG1 and MG2 and is then output to the sun gear 41. The ratio of the rotational speed Ne of the engine 22 to the rotational speed of the sun gear 41 as the output element is varied continuously in a stepless manner by controlling the rotational speed of the motor MG2. FIG. 10 is an explanatory view exemplifying an alignment chart showing a state of torques and rotational speeds of elements included in the power distribution integration mechanism 40 and the reduction gear mechanism 50 in the second torque conversion mode.

In the hybrid vehicle 20 of the embodiment, the first torque conversion mode and the second torque conversion mode are alternately switched over with a change of the change speed state (speed ratio) in the transmission 60. Such switchover prevents the rotational speed Nm1 or Nm2 of the motor MG1 or MG2 functioning as the generator from having a negative value with an increase in rotational speed Nm2 or Nm1 of the motor MG2 or MG1 functioning as the motor. This effectively prevents the occurrence of power circulation in the first torque conversion mode, as well as the occurrence of power circulation in the second torque conversion mode. The power circulation in the first torque conversion mode is triggered by the negative rotational speed of the motor MG1 and causes the motor MG2 to consume part of the power output to the carrier shaft 45a and generate electric power, while causing the motor MG1 to consume the electric power generated by the motor MG2 and output driving power. The power circulation in the second torque conversion mode is triggered by the negative rotational speed of the motor MG2 and causes the motor MG1 to consume part of the power output to the first motor shaft 46 and generate electric power, while causing the motor MG2 to consume the electric power generated by the motor MG1 and output driving power. Such prevention of the power circulation desirably improves the power transmission efficiency in a wider drive range. The prevention of the power circulation also reduces the maximum required rotational speeds of the motors MG1 and MG2 and thereby enables size reduction of the motors MG1 and MG2. In the hybrid vehicle 20 of the embodiment, the output power of the engine 22 can be mechanically (directly) transmitted to the driveshaft 69 at the fixed speed ratios uniquely set for the 1^{st} speed-2^{nd} speed simultaneous engagement state, the 2^{nd} speed-3^{rd} speed simultaneous engagement state, and the 3^{rd} speed fixing state. This desirably increases the potential for mechanical output of the power from the engine 22 to the driveshaft 69 without conversion into electrical energy and thereby further enhances the power transmission efficiency in the wider drive range. In a general power output apparatus equipped with an engine, two motors, and a differential rotation mechanism such as a planetary gear mechanism, the relatively large reduction gear ratio between the engine and a driveshaft increases the potential for conversion of the engine output power into electrical energy. This undesirably decreases the power transmission efficiency and tends to cause heat generation in the motors MG1 and MG2. The simultaneous engagement mode described above is thus especially advantageous for the relatively large reduction gear ratio between the engine 22 and the driveshaft 69.

Next, a motor drive mode of the hybrid vehicle 20 will be described with reference to FIG. 11. In, the motor drive mode, at least one of the motors MG1 and MG2 is driven with supply of electric power from the battery 35 to output driving power while the engine 22 is stopped. In the hybrid vehicle 20 of the embodiment, the motor drive mode includes a clutch engagement one-motor drive mode, a clutch release one-motor drive mode, and a two-motor drive mode. In the clutch engagement one-motor drive mode, the clutch C0 is engaged, and the transmission 60 is set in the first change speed state or the third change speed state to allow the power output from only the motor MG2 or is set in the second change speed state to allow the power output from only the motor MG1. In the clutch engagement one-motor drive mode, the clutch C0 is set to connect the sun gear 41 of the power distribution integration mechanism 40 with the first motor shaft 46. Accordingly, the motor MG1 or MG2 in the state of no power output thus follows the motor MG2 or MG1 in the state of power output to run idle as shown by the broken line in FIG. 11. In the clutch release one-motor drive mode, the clutch C0 is released, and the transmission 60 is set in the first change speed state or the third change speed state to allow the power output from only the motor MG2 or is set in the second change speed state to allow the power output from only the motor MG1. In the clutch release one-motor drive mode, the clutch C0 is released to disconnect the sun gear 41 from the first motor shaft 46. As shown by the one-dot chain line and the two-dot chain line in FIG. 11, such disconnection effectively avoids a following rotation of the crankshaft 26 of the engine 22 that is stopped, as well as a following rotation of the motor MG1 or MG2 in the state of no power output, thereby preventing a decrease in power transmission efficiency. In the two-motor drive mode, the clutch C0 is released, and at least one of the motors MG1 and MG2 is driven and controlled while the transmission 60 is set in the 1^{st} speed-2^{nd} speed simultaneous engagement state or the 2^{nd} speed-3^{rd} speed simultaneous engagement state by means of the brakes B1 and B2 and the clutch C1. Such setting and drive control effectively avoids the following rotation of the engine 22 and enables the power output from both the motors MG1 and MG2 and transmission of a large driving power to the driveshaft 69 in the motor drive mode. This two-motor drive mode is especially suitable for a hill start and ensures the favorable towing performance during the motor drive of the hybrid vehicle 20.

In the hybrid vehicle 20 of the embodiment, the change speed state (speed ratio) of the transmission 60 can be readily changed to enable the efficient power transmission to the driveshaft 69 when the clutch release one-motor drive mode is selected. When the clutch C0 is released and the transmission 60 is set in the first change speed state to allow the power output from only the motor MG2 while fixing the ring gear 62 of the first change speed planetary gear mechanism PG1 to the transmission case by means of the brake B1, for example, the motor MG1 may be driven and controlled to make the rotational speed of the ring gear 66 of the second change speed planetary gear mechanism PG2 approach to 0 so as to shift up the speed ratio of the transmission 60. Then, the brake B2 may be set to fix the ring gear 66 of the second change speed planetary gear mechanism PG2 to the transmission case so as to set the transmission 60 in the above 1^{st} speed-2^{nd} speed simultaneous engagement state. Further, the brake B1 may be released so as to release the ring gear 62 of the first change speed planetary gear mechanism PG1 in the rotatable manner and to allow the power output from only the motor MG1, so that the transmission 60 can be set in the second change speed state to change the speed ratio in the shift up side (second speed). In order to shift up the speed ratio of the transmission 60 while the clutch C0 is released and the transmission 60 is set in the second change speed state to allow the power output from only the motor MG1, the motor MG2 is driven and controlled to synchronize the rotational speed of the ring gear 62 of the first change speed planetary gear mechanism PG1 with the rotational speed of the carrier 64 (the driveshaft 69). Then, the clutch C1 may be controlled to couple the ring gear 62 with the carrier 64 of the first change speed planetary gear mechanism PG1 so as to shift the transmission 60 from the second change speed state to the 2^{nd} speed-3^{rd} speed simultaneous engagement state. Further, the brake B2 may be released to release the ring gear 66 of the second change speed planetary gear mechanism PG2 in the rotatable manner and to allow the power output from only the motor MG2, so that the transmission 60 can be set in the third change speed state to change the speed ratio in the shift up side (third speed). In the hybrid vehicle 20 of the embodiment, the transmission 60 is used to change the rotational speed of the carrier shaft 45a and the first motor shaft 46 and amplify the torque in the motor drive mode, thereby desirably reducing the maximum required torques of the motors MG1 and MG2 and enabling size reduction of the motors MG1 and MG2. In the hybrid vehicle 20, the simultaneous engagement mode or the two-motor drive mode is once performed when the speed ratio of the transmission 60 is changed during the motor drive. Accordingly, it is possible to prevent a torque loss upon the change of the speed ratio and to ensure an extremely smooth change of the speed ratio with causing no significant shock.

The speed ratio of the transmission 60 may be shifted down in the motor drive mode according to the procedure basically reverse to the above description. In response to an increase of a driving force demand or a decrease of the state of charge SOC of the battery 35 in the clutch engagement one-motor drive mode, the motor MG1 or MG2 to be made into the state of no power output corresponding to the setting of the speed ratio in the transmission 60 is driven and controlled to crank and start up the engine 22. In response to the increase of the driving force demand or the decrease of the state of charge SOC of the battery 35 in the clutch release one-motor drive mode, on the other hand, the motor MG1 or MG2 in the state of no power output is driven and controlled to synchronize its rotational speed Nm1 or Nm2 with the rotational speed of the sun gear 41 or with the rotational speed of the carrier 45 in the power distribution integration mechanism 40. After the clutch C0 is engaged, the motor MG1 or MG2 is subsequently driven and controlled to crank and start up the engine 22. The engine 22 can thus be started up with smooth power transmission to the driveshaft 69. At the startup of the engine 22 in the two-motor drive mode, after selection of one of the motors MG1 and MG2 as a motor of continuously outputting power corresponding to a target speed ratio set in the transmission 60, power conversion is performed to transmit the power of the other motor MG2 or MG1 of not continuously outputting power to the one motor MG1 or MG2 of continuously outputting power. On completion of the power conversion, the brake B2 or the brake B1 is released to disconnect the other motor MG2 or MG1 of not continuously outputting power from the transmission 60. Then, the other motor MG2 or MG1 is driven and controlled to synchronize its rotational speed Nm2 or Nm1 with the rotational speed of the carrier 45 or with the rotational speed of the sun gear 41 in the power distribution integration mechanism 40. Further, the clutch C0 is engaged and the other motor MG2 or MG1 is driven and controlled to motor and start up the engine 22. The engine 22 can thus be started up with smooth power transmission to the driveshaft 69.

As has been described above, the hybrid vehicle 20 of the embodiment includes the transmission 60 equipped with the sun gear 61 connected with the carrier shaft 45a and the sun gear 65 connected with the first motor shaft 46 as the power input elements, and the carrier 64 connected with the driveshaft 69 as the power input element. The transmission 60 is capable of selectively transmitting power from the sun gears 61 and at predetermined respective speed ratios to the carrier 64 (driveshaft 69). The transmission 60 includes the transmission case 600 that houses the plurality of elements including the sun gears 61 and 65, the carrier 64 and the like, the oil pan 605 defined in the lower portion within the transmission case 600 and storing the transmission oil capable at least of lubricating the constituents of the transmission 60, the electromagnetic actuator 101 that is connected with the movable engagement member 151 and allows the connection between the ring gear 62 of the first change speed planetary gear mechanism PG1 and the locking member 601 and the release of the connection, the electromagnetic actuator 102 that is connected with the movable engagement member 152 and allows the connection between the ring gear 66 of the second change speed planetary gear mechanism PG2 and the locking member 602 and the release of the connection, the electromagnetic actuator 103 that is connected with the movable engagement member 153 and allows the connection between the fixing member 68 secured to the first motor shaft 46 and the locking member 603 and the release of the connection, and the electromagnetic actuator 104 that is connected with the movable engagement member 154 and allows the connection between the carrier 64 or the output element of the first change speed planetary gear mechanism PG1 and the ring gear 62 or the fixable element of the mechanism PG1 and the release of the connection. These electromagnetic actuators 101-104 are disposed in the oil pan 605 defined in the lower portion within the transmission case 600.

As described above, each of the movable engagement members 151-154 capable of engaging with at least two corresponding elements is connected with a corresponding one of the electromagnetic actuators 101-104 disposed in the lower portion within the transmission case 600. Thus, the whole of the transmission 60 can be configured to be compact in comparison with an apparatus including an electromagnetic actuator having a cylindrical shape. Further, lubricating function and shock absorbing function of the transmission oil ensure smooth operation of the electromagnetic actuators 101-104 and reduce operation noise of the electromagnetic actuators 101-104 by disposing the electromagnetic actuators 101-104 in place within the oil pan 605. The whole body of the electromagnetic actuators 101-104 may be positioned below a fluid level of the transmission oil. A part of the body of the electromagnetic actuators 101-104 may be positioned above the fluid level of the transmission oil. That is, locations of the electromagnetic actuators 101-104 in the oil pan 605 may be selected in accordance with characteristics of the transmission oil so as to ensure smooth operation of the electromagnetic actuators 101-104 and reduce operation noise of the electromagnetic actuators 101-104.

The electromagnetic actuators 101-104 include the actuator shaft 110 connected with a corresponding one of the movable engagement members 151-154 and movable in the predetermined direction, the permanent magnet 111 secured to the actuator shaft 110, the couple of fixed magnetic poles 112 and 113 arranged so that the permanent magnet 111 is positioned between the fixed magnetic poles 112 and 113, and the drive circuit 105 that changes the polarity of each of the fixed magnetic poles 112 and 113. According to the electromagnetic actuators 101-104, it is possible to release the magnetic coupling between the permanent magnet 111 and one of the fixed magnetic poles 112 and 113 and to move the actuator shaft 110 together with the movable engagement members 151-154 by changing the polarity of each of the fixed magnetic poles 112 and 113. After the magnetic coupling between the permanent magnet 11 and the other of the fixed magnetic poles 112 and 113, it is possible to readily and reliably retain the connection or the disconnection between the two elements by means of the movable engagement members 151-154 even if the setting of the polarity of each of the fixed magnetic poles 112 and 113 is released. Further, the shock absorbing function of the transmission oil favorably reduces noise due to a collision between the permanent magnetic 111 and the fixed magnetic pole 112 or 113 by disposing the electromagnetic actuator 101-104 in the oil chamber.

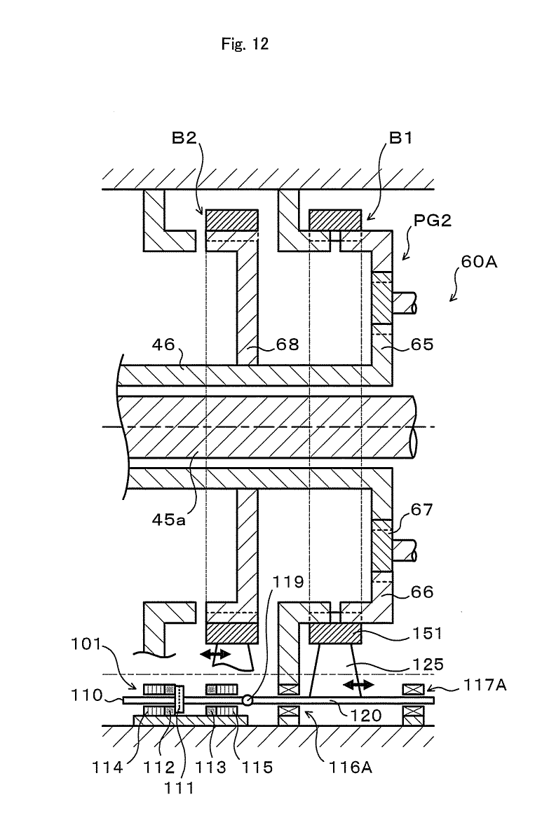

The transmission 60 includes the movable shaft 120 secured to the corresponding one of the movable engagement members 151-154 and connected with the actuator shaft 110. In the embodiment, the actuator shaft 110 and the movable shaft 120 are arranged offset from each other. Thus, the electromagnetic actuators 101-104 can be flexibly disposed within the oil pan 605, so that the whole of the transmission 60 including a plurality of sets of the movable engagement members 151-154 and the electromagnetic actuators 101-104 can be configured to be compact. In the embodiment, the actuator shaft 110 and the movable shaft 120 are respectively movable in the moving direction of the movable engagement members 151-154. Further, the actuator shaft 110 and the movable shaft 120 are offset from each other in the direction orthogonal to the moving direction of the movable engagement members 151-154. Thus, it is possible to smoothly move the movable engagement members 151-154 and to flexibly dispose the electromagnetic actuators 101-104 within the oil pan 605. In the embodiment, the actuator shaft 110 and the movable shaft 120 are arranged offset from each other in the top to bottom direction in the figure that is the direction orthogonal to the moving direction (axial direction of the carrier shaft 45a and the first motor shaft 46) of the movable engagement member 151 (−154). However, the present invention is not limited to this. As transmission 60A shown in FIG. 12, the actuator shaft 110 and the movable shaft 120 may be arranged offset from each other in a width direction of the transmission case 600 (direction orthogonal to the sheet) that is the direction orthogonal to the moving direction of the movable engagement members 151-154 (axial direction of the carrier shaft 45a and the first motor shaft 46). Further, the both ends of the movable shaft 120 may be slidably supported by bearings 116A and 117A, thereby preventing the movable shaft 120 from inclining and smoothly moving the movable shaft 120 or the movable engagement member 151-154. In the transmission 60 of the embodiment, the actuator shaft 120 and the corresponding one of the movable engagement members 151-154 are connected with each other via the connecting member 125. Further, the connecting member 125 is formed so that the size of the portion secured to the movable shaft 120 is larger than the size of the portion secured to the movable engagement members 151-154. Thus, rigidity of the securing portion between the movable shaft 120 and the connecting member 125 can be increased, thereby preventing the movable shaft 120 from inclining and smoothly moving the movable shaft 120 even if the movable engagement members 151-154 are formed as the relatively thin ring-shaped member.

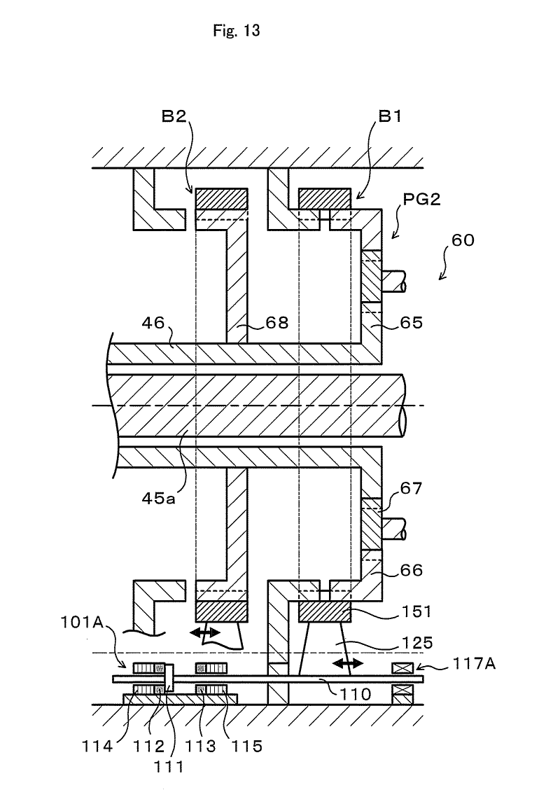

In the transmission 60 of the embodiment, the actuator shaft 110 and the corresponding one of the movable engagement members 151-154 are connected each other via the movable shaft 120. However, the present invention is not limited to this. As an electromagnetic actuator 101A shown in FIG. 13, the actuator shaft 110 may be connected with the movable engagement member 151(-154) via the connecting member 125 without the movable shaft. In this configuration, as shown in FIG. 13, the bearing 117A supports one end portion of the actuator shaft 110. The one end portion is farther than the other end of the actuator shaft 110 from the permanent magnet 111. Thus, it is possible to prevent the actuator shaft 110 from inclining and to smoothly move the actuator shaft 110 or the movable engagement members 151-154. Further, in such a configuration, it may be possible to provide the function of the bearing to one of the fixed magnetic poles 112 and 113 and the coils 114 and 115. In the electromagnetic actuator 101A, the connecting member 125 may be formed so that so that the size of the portion secured to the actuator shaft 110 is larger than the size of the portion secured to the movable engagement members 151-154. Thus, rigidity of the securing portion between the actuator shaft 110 and the connecting member 125 can be increased, thereby preventing the actuator shaft 110 from inclining and smoothly moving the actuator shaft 110 even if the movable engagement members 151-154 are formed as the relatively thin ring-shaped member.

The transmission 60 includes the three element-type first change speed planetary gear mechanism PG1 and the three element-type second change speed planetary gear mechanism PG2. The transmission 60 can be arranged coaxially with and in the downstream (in the rear portion of the vehicle body) of the engine 22, the motors MG1 and MG2, and the power distribution integration mechanism 40. The transmission 60 enables significant size reduction both in the axial direction and in the radial direction in comparison with the parallel shaft-type transmission. The power output apparatus of the embodiment including the engine 22, the motors MG1 and MG2, the power distribution integration mechanism 40, and the transmission 60 is thus space-saving to be especially suitable for mounting on the rear-wheel drive hybrid vehicle 20. In the hybrid vehicle 20, the power distribution integration mechanism 40 is arranged coaxially with the motors MG1 and MG2 and is located between the motors MG1 and MG2 coaxially arranged with each other, thereby enabling size reduction of the motors MG1 and MG2 in the radial direction. Thus, the power output apparatus is accordingly small-sized and is specifically suitable for being mounted on the hybrid vehicle 20 of the rear-wheel drive-based system. The power distribution integration mechanism 40 constructed as the three element-type planetary gear mechanism allows the further size reduction and causes the power output apparatus to be small-size and suitable for being mounted on the vehicle. According to the transmission 60, when the brake B1 or the first fixation device fixes the ring gear 62 of the first change speed planetary gear mechanism PG1 in the non-rotatable manner, the carrier 45 or the first element of the power distribution integration mechanism 40 works as the output element, the motor MG2 connected with the carrier 45 works as the motor, and the motor MG1 connected with the sun gear 41 or the second element of the power distribution integration mechanism 40 working as the reactive element works as the generator. Further, when the brake B2 or the second fixation device fixes the ring gear 66 of the second change speed planetary gear mechanism PG2 in the non-rotatable manner, the sun gear 41 or the second element of the power distribution integration mechanism 40 works as the output element, the motor MG1 connected with the sun gear 41 works as the motor, and the motor MG2 connected with the carrier 45 or the first element of the power distribution integration, mechanism 40 working as the reactive element works as the generator. The hybrid vehicle 20 adequately controlled to change the fixation of the ring gear 62 of the first change speed planetary gear mechanism PG1 and the fixation of the ring gear 66 of the second change speed planetary gear mechanism PG2. Accordingly, the hybrid vehicle 20 effectively prevents the occurrence of the power circulation by retaining the rotational speed Nm1 or Nm2 of the motor MG1 or MG2 functioning as the generator at a positive value in response to the increase in rotational speed Nm2 or Nm1 of the motor MG2 or MG1 functioning as the motor. Further, when the brakes B1 and B2 of the transmission 60 fix the ring gear 62 and 66 of the first and second change speed planetary gear mechanism PG1 and PG2, the power from the engine 22 can be mechanically transmitted to the driveshaft 69 at the fixed speed ratio. Accordingly, the hybrid vehicle 20 has the improved power transmission efficiency in a wider drive range, thereby ensuring the enhanced fuel efficiency and the improved driving performance.

The transmission 60 includes the clutch C1 or the change-speed connecting-disconnecting device configured to allow the connection between the carrier 64 or the output element and the ring gear 62 or the fixable element of the first change speed planetary gear mechanism PG1 and the release of the connection. Accordingly, when the carrier 64 and the ring gear 62 of the first change speed planetary gear mechanism PG1 are connected with each other while fixing the ring gear 66 or the fixable element of the second change speed planetary gear mechanism PG2 in the non-rotatable manner by the brake B2, the transmission 60 is set in the 2^{nd} speed-3^{rd} speed simultaneous engagement state. In the 2^{nd} speed-3^{rd} speed simultaneous engagement state, the power from the engine 22 can be mechanically transmitted to the driveshaft 69 at the fixed speed ratio different from the speed ratio of the 1^{st} speed-2^{nd} speed simultaneous engagement state of fixing both the ring gear 62 of the first change speed planetary gear mechanism PG1 and the ring gear 66 of the second change speed planetary gear mechanism PG2 in the non-rotatable manner by the brake B1 and B2. When the brake B2 is released to release the ring gear 66 of the second change speed planetary gear mechanism PG2 in the rotatable manner in the 2^{nd} speed-3^{rd} speed simultaneous engagement state, the elements of the first change speed planetary gear mechanism PG1 is substantially locked and integrally rotate, so that the power from the carrier 45 or the first element of the power distribution integration mechanism 40 can be directly transmitted to the driveshaft 69. Thus, the hybrid vehicle 20 has the improved power transmission efficiency in a wider drive range. The transmission 60 may include a clutch capable of a connection between the carrier 64 or the output element and the ring gear 66 or the fixable element of the second change speed planetary gear mechanism PG2 and a release of the connection.

In the hybrid vehicle of the embodiment, the transmission 60 includes the brake B3 or the third fixation device capable of fixing the sun gear 41 or the second element of the power distribution integration mechanism 40. The sun gear 41 (reactive element) or the second element of the power distribution integration mechanism 40 that connected with the motor MG1 working as the generator may be fixed when the transmission 60 is set in the third change speed state by connecting the carrier 64 or the output element with the ring gear 62 or the fixable element of the first change speed planetary gear mechanism PG1. Thus, the power from the engine 22 can be mechanically transmitted to the driveshaft 69 at the fixed speed ratio different from the fixed speed ratio of the 1^{st} speed-2^{nd} speed simultaneous engagement state of fixing both the ring gear 62 of the first change speed planetary gear mechanism PG1 and the ring gear 66 of the second change speed planetary gear mechanism PG2 in the non-rotatable manner by the brakes B1 and B2 and from the fixed speed ratio of the 2^{nd} speed-3^{rd} speed simultaneous engagement state of coupling the ring gear 62 of the first change speed planetary gear mechanism PG1 with the carrier 64. Accordingly, the hybrid vehicle 20 has the improved power transmission efficiency in a wider drive range. The brake B3 or the third fixation device may be configured to fix the carrier 45 or the first element of the power distribution integration mechanism 40 when the transmission 60 includes the clutch capable of the connection between the carrier 64 or the output element and the ring gear 66 or the fixable element of the second change speed planetary gear mechanism PG2 and a release of the connection. The brake 83 may be separated from the transmission 60.

The hybrid vehicle 20 of the embodiment includes the clutch C0 that connects and disconnects the sun gear shaft 41a with and from the first motor shaft 46, that is, connects and disconnects the sun gear 41 with and from the motor MG1. When the clutch C0 is released to disconnect the sun gear shaft 41a from the first motor shaft 46, the function of the power distribution integration mechanism 40 causes the engine 22 to be substantially separated from the motors MG1 and MG2 and the transmission 60. Thus, the power from at least one of the motors MG1 and MG2 can be transmitted to the driveshaft 69 with high efficiency with the change of the speed ratio of the transmission 60 when the clutch C0 is release and the engine 22 is stopped in the hybrid vehicle 20. Accordingly, the hybrid vehicle 20 desirably decreases the maximum torques required for the motors MG1 and MG2 and thereby allows size reduction of the motors MG1 and MG2. The clutch C0 is not restricted to the structure of connecting and disconnecting the sun gear 41 with and from the motor MG1. The clutch C0 may be configured to connect and disconnect the carrier 45 (first element) with and from the carrier shaft 45a (motor MG2) or may be configured to connect and disconnect the crankshaft 26 of the engine 22 with and from the ring gear 42 (third element).

The hybrid vehicle 20 of the embodiment is equipped with the power output apparatus that includes the engine 22, the motors MG1 and MG2, the power distribution integration mechanism 40, and the transmission 60 and is configured to drive the rear wheels RWa and RWb with the power from the driveshaft 69. This power output apparatus is small-sized and is especially suitable for the hybrid vehicle 20 of the rear-wheel drive-based system, while improving the power transmission efficiency in the wider driving range. The hybrid vehicle 20 of the above configuration accordingly has both the high fuel consumption and the good driving performance. The first and second change speed planetary gear mechanism PG1 and PG2 may be a double pinion planetary gear mechanism. The hybrid vehicle 20 of the embodiment may be constructed as a rear wheel drive-based four wheel drive vehicle. In the embodiment, the power output apparatus is mounted on the hybrid vehicle 20. The power output apparatus of the invention is, however, not restrictively mounted on the hybrid vehicle, but may be mounted on diversity of moving bodies including various automobiles and other vehicles, boats and ships, and air craft or may be built in stationary equipment including construction machinery.

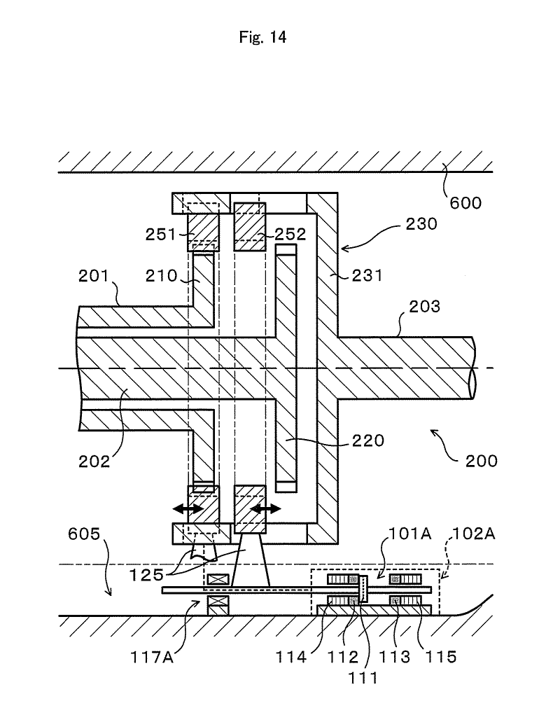

FIG. 14 is a schematic block diagram of a clutch 200 in a modified example of the power transmitting apparatus according to the invention. The clutch 200 shown in FIG. 14 is configured to selectively connect a first rotating shaft (first rotating element) 201 and a second rotating shaft (second rotating element) 202 coaxial with the first rotating shaft 201 to a third rotating shaft (third rotating element) 203. The clutch 200 is a dog clutch that includes a first engagement portion 210 provided in the first rotating shaft 201, a second engagement portion 220 provided in the second rotating shaft 202 to be spaced from the first engagement portion 210, a third engagement portion 230 provided in the third rotating shaft 203 to be located around the first and second engagement portions 210 and 220, a first movable engagement member 251 capable of engaging with both the first and third engagement portions 210 and 230 and moving in an axial direction thereof, a second movable engagement member 252 capable of engaging with both the second and third engagement portions 220 and 230 and moving in an axial direction thereof, a first electromagnetic actuator 101A connected with the first engagement member 251 via a connecting member 125, and a second electromagnetic actuator 102A connected with the second engagement member 252 via a connecting member 125. In the above clutch 200, the movable engagement members 251 and 252 are connected with a corresponding one of the electromagnetic actuators 101A and 102A which are respectively disposed in the lower portion within the transmission case 600, so that the whole of the apparatus can be configured to be compact in comparison with the apparatus including the electromagnetic actuator having the cylindrical shape. Further, lubricating function and shock absorbing function of the transmission oil ensure smooth operation of the electromagnetic actuators 101A and 102A and reduce operation noise of the electromagnetic actuators 101A and 102A by disposing the electromagnetic actuators 101A and 102A in place within the oil pan 605. In the clutch 200, the first and second rotating shafts 201 and 202 may be defined as the power input elements and the third rotating shaft 203 may be defined as the power output element. Further, in the clutch 200, the third rotating shaft 203 may be defined as the power input element and the first and second rotating shafts 201 and 202 may be defined as the power output elements.

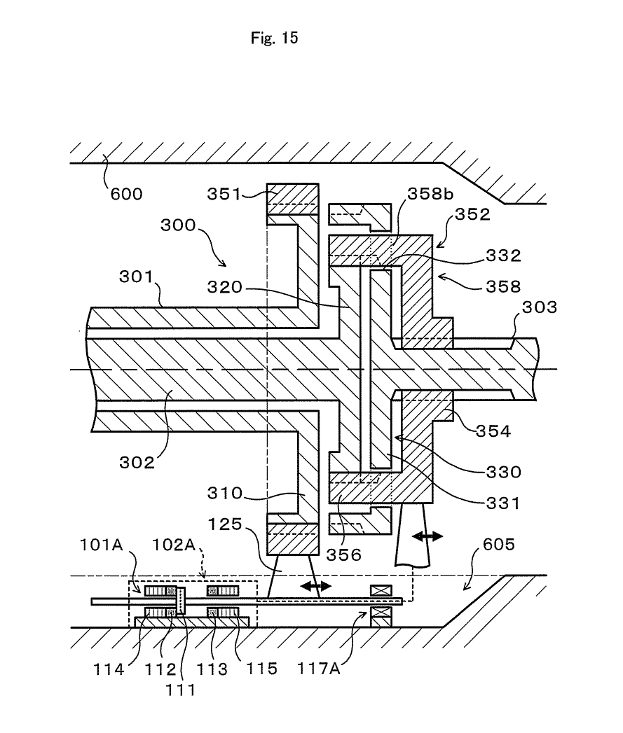

FIG. 15 is a schematic block diagram of a clutch 300 in a modified example of the power transmitting apparatus according to the invention. The clutch 300 shown in FIG. 15 is also configured to selectively connect a first rotating shaft (first rotating element) 301 and a second rotating shaft (second rotating element) 302 coaxial with the first rotating shaft 301 to a third rotating shaft (third rotating element) 303. The clutch 300 is a dog clutch that includes a first engagement portion 310 provided in the first rotating shaft 301, a second engagement portion 320 provided in the second rotating shaft 302, a third engagement portion 330 provided in the third rotating shaft 303 and having a flange portion 331 that faces with the second engagement portion 320, a first movable engagement member 351 capable of engaging with both the first and third engagement portions 310 and 330, a second movable engagement member 352, a first electromagnetic actuator 101A connected with the first engagement member 351 via a connecting member 125, and a second electromagnetic actuator 102A connected with the second engagement member 352 via a connecting member 125. The movable engagement portion 352 includes a sliding portion 354 slidably supported by the third rotating shaft 303, an engagement portion 356 engaging with the second engagement portion 320 at a side near to the rotating shaft 302 rather than the flange portion 331, and connecting portion 358 connecting the siding portion 354 with the engagement portion 356 and having a projection 358b that is inserted into a hole portion 332 of the flange portion 331. In the above clutch 300, the movable engagement members 351 and 352 are also connected with a corresponding one of the electromagnetic actuators 101A and 102A which are respectively disposed in the lower portion within the transmission case 600, so that the whole of the apparatus can be configured to be compact in comparison with the apparatus including the electromagnetic actuator having the cylindrical shape. Further, lubricating function and shock absorbing function of the transmission oil ensure smooth operation of the electromagnetic actuators 101A and 102A and reduce operation noise of the electromagnetic actuators 101A and 102A by disposing the electromagnetic actuators 101A and 102A in place within the oil pan 605. In the clutch 300, the first and second rotating shafts 301 and 302 may be defined as the power input elements and the third rotating shaft 303 may be defined as the power output element. Further, in the clutch 300, the third rotating shaft 303 may be defined as the power input element and the first and second rotating shafts 301 and 302 may be defined as the power output elements.

There may be many modifications, changes, and alterations without departing from the scope or spirit of the main characteristics of the present invention. The scope and spirit of the present invention are indicated by the appended claims, rather than by the foregoing description.

### INDUSTRIAL APPLICABILITY

The technique of the invention is preferably applied to the manufacturing industries of a power transmitting apparatus.

1. A power transmitting apparatus that has a plurality of elements including at least two rotating elements and is capable of transmitting power between the two rotating elements, the power transmitting apparatus comprising:
a casing that houses the plurality of elements;
a lubricating medium reservoir defined in a lower portion within the casing, the lubricating medium reservoir storing a lubricating medium capable at least of lubricating the plurality of elements; and
a connecting unit including a movable engagement member capable of engaging with at least two elements among the plurality of elements, and an electromagnetic actuator disposed in the lubricating medium reservoir and connected with the movable engagement member, the electromagnetic actuator moving the movable engagement member to allow a connection between at least the two elements among the plurality of elements and a release of the connection.

2. A power transmitting apparatus according to claim 1, wherein the electromagnetic actuator includes:
an actuator shaft connected with the movable engagement member and movable in a predetermined direction;
a permanent magnet secured to the actuator shaft;
a couple of fixed magnetic poles arranged so that the permanent magnet is positioned between the fixed magnetic poles; and
a polarity changing device capable of changing a polarity of each of the fixed magnetic poles.

3. A power transmitting apparatus according to claim 2, further comprising:
a bearing that supports one end portion of the actuator shaft, the one end portion being farther than the other end of the actuator shaft from the permanent magnet.

4. A power transmitting apparatus according to claim 2, wherein the movable engagement member and the actuator shaft are connected with each other via a connecting member, and wherein the connecting member is formed so that a size of a portion secured to the actuator shaft is larger than a size of a portion secured to the movable engagement member.

5. A power transmitting apparatus according to claim 2, further comprising:
a movable shaft secured to the movable engagement member and connected with the actuator shaft,
wherein the actuator shaft and the movable shaft are arranged offset from each other.

6. A power transmitting apparatus according to claim 5, wherein the actuator shaft and the movable shaft are respectively movable in a moving direction of the movable engagement member, and wherein the actuator shaft and the movable shaft are offset from each other in a direction orthogonal to the moving direction of the movable engagement member.

7. A power transmitting apparatus according to claim 5, further comprising:
bearings that supports both end portions of the movable shaft.

8. A power transmitting apparatus according to claim 5, wherein the movable engagement member and the movable shaft are connected with each other via a connecting member, and wherein the connecting member is formed so that a size of a portion secured to the movable shaft is larger than a size of a portion secured to the movable engagement member.

9. A power transmitting apparatus according to claim 1, wherein the elements includes two power input elements and one power output element, and wherein power from the two power input elements is selectively transmitted to the power output element.

10. A power transmitting apparatus according to claim 1, wherein the elements includes one power input element and two power output elements, and wherein power from the power input element is selectively transmitted to the two power output elements.
